(19) United States
(12) Patent Application Publication
(10) Pub. No.: US 2024/0394601 A1
(43) Pub. Date: Nov. 28, 2024

(54) Actor-Oriented Architecture Assessment Tool

(71) Applicant: CHILDREN'S HOSPITAL MEDICAL CENTER, CINCINNATI, OH (US)

(72) Inventors: MICHAEL SEID, MASON, OH (US); DAVID HARTLEY, ROCKVILLE, MD (US)

(73) Assignee: CHILDREN'S HOSPITAL MEDICAL CENTER, CINCINNATI, OH (US)

(21) Appl. No.: 18/673,812

(22) Filed: May 24, 2024

Related U.S. Application Data
(60) Provisional application No. 63/504,038, filed on May 24, 2023.

(51) Int. Cl. G06N 20/00

(52) U.S. Cl. CPC G06N 20/00

(57) ABSTRACT

Disclosed herein are systems and methods for assessing a learning network (LN). Aspects may include collecting data related to an organization to be assessed, analyzing the data with respect to a set of indicators associated with an organizational ontology of an actor-oriented architecture (AOA), determining a strength of LN capabilities for each indicator in the set of indicators, generating a dashboard to graphically communicate at least one summary-statistic indicative of a strength of at least one LN capability.

### CROSS-REFERENCE TO RELATED APPLICATIONS

The present application claims priority to U.S. Provisional Application No. 63/504,038, filed May 24, 2023, which is incorporated herein by reference.

### BACKGROUND

An actor-oriented architecture (AOA) is a scheme for describing how groups of people allocate resources and tasks and how decisions about these are made. Fjeldstad, et. al., The Architecture of Collaboration, Strategic Management Journal, 33:734-750 (2012), introduced the AOA for effective collaborative environments. The AOA scheme is composed of three main elements: (1) actors who have common purpose and the capabilities and values to self-organize; (2) commons where the actors accumulate and share resources; and (3) protocols, processes, and infrastructures that enable multi-actor collaboration. As a result, successful, robust, scalable organizations can be described by the actor-oriented architecture (AOA).

The current disclosure relates to real-world collaborative organizations including collaborative learning health systems (CLHSs), also known as learning health networks (LHNs) or more simply learning networks (LNs). LNs are groups of providers and patients—often across hospitals—that use a specific organizational architecture to facilitate the production and sharing of data (e.g., lab tests, symptoms) and knowledge (e.g., how to care for patients at home) enabling stakeholder (patients and families, clinicians, researchers) collaboration to improve care delivery processes and outcomes such as: (a) the rate of entering remission; (b) increasing the time spent in remssion; and (c) improving quality of life such as better symptom management, decreased side effects, and better psycho-social health among others. Learning networks are often condition-based (e.g., transplant, inflammatory bowel disease, bipolar disorder). In a healthcare setting, for example, a LN includes a plurality of patient agents and a plurality of clinician agents sharing information about treatments and outcomes. Real learning networks today employ experimentation to identify ways to improve—a slow and costly process limited by resources and imagination. CLHSs hold promise for transforming health outcomes. Britto M T, Fuller S C, Kaplan H C, Kotagal U, Lannon C, Margolis P A, Muething S E, Schoettker P J, Seid M. Using a Network Organisational Architecture to Support the Development of Learning Healthcare Systems. BMJ Qual Saf. 2018 November; 27 (11): 937-946. doi: 10.1136/bmjqs-2017-007219 (https://pubmed.ncbi.nlm.nih.gov/29438072/) discusses that CLHSs facilitate collaboration at scale via the AOA and have identified empirical evidence for AOA in LHSs.

CLHSs would be expected to be more effective if they facilitated via AOAs, but how do we know if a CLHS (or other organization) is an AOA and to what degree it has the corresponding structure? What is needed, but is lacking at present, is a tool to allow the objective, reproducible assessment of how a particular CLHS conforms to the different elements of the AOA.

### SUMMARY

Systems and methods are disclosed herein for assessing a learning network (LN). A computer-implemented method for assessing a learning network (LN) may include one or more operations for collecting data related to an organization to be assessed, analyzing the data with respect to a set of indicators associated with an organizational ontology of an actor-oriented architecture (AOA), determining a strength of LN capabilities for each indicator in the set of indicators, and generating a dashboard, on a graphical user interface, graphically communicating at least one summary-statistic indicative of the strength of LN capabilities. In examples, the data may include LN capabilities data indidcative of at least one of: LN structure, information use, and function. One or more non-transitory memory devices including computer instructions configured to direct one or more computer processors to perform the computer-implemented methods discussed herein.

In another example, a computerized system may include: an ontology input module configured provide a specification of an organizational ontology, the ontology including a set of indicators associated with an organization, a data collection module comprising data related to an organization to be assessed, a category coding module configured to analyze data from the data collection module with respect to the set of indicators, a scoring module configured to perform at least one of: scoring the analysis and generating statistics from the analysis conducted by the category coding module, and an output dissemination module configured to output a least one of: a score and a statistic to a user.

Sometimes organizations mine internal business data to try to optimize one or more tactical or strategic outcomes (this is the domain of business intelligence), for example, identifying a plurality of key performance indicators (KPIs, https://pumble.com/learn/collaboration/how-to-measure-collaboration/) and managing the organization to achieve KPI goals. This is an incomplete approach to optimizing organization structure and internal interactions, however, because KPIs are often arbitrary and change over time according to changing goals, leadership, and other factors. Other methods aim to measure collaboration by itself (e.g.,
https://www.hbs.edu/ris/Publication % 20Files/MeasuringCollaboration_May2020_e5654df5-2f2e-4752-aa23-67c05e167107.pdf;
https://www.aeaweb.org/articles?id=10.1257/pandp.20201068;
https://www.sciencedirect.com/science/article/abs/pii/S0272696307000101?casa_token=IsIL aGm4154AAAAA:_fTFE0IbRhp6M90gObtFfi0Oh5Fd67_PTGF2-zNFsxU1f095yPD-nyRWzuXzDd3x0d3q3Lz). The current disclosure is concerned rather with measuring the fidelity of an organizational structure to a theoretical model (the Actor Oriented Architecture) that is known to have desirable features (e.g., collaboration facilitation, improvement as culture, seamless sharing of information etc).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 illustrates an exemplary method according to the present disclosure.

FIG. 2 illustrates example categories for an AOA.

FIG. 3 illustrates an example AOA Assessment Tool system.

FIG. 4 illustrates an example concept of operations.

FIG. 5 illustrates an example AOA assessment tool interactions with data sources.

FIG. 6 illustrates an example computing device.

### DETAILED DESCRIPTION

The current disclosure describes a method and tool for reproducibly assessing the completeness of an organization in terms of being a functional AOA.

Aspects of the present disclosure provide a methodology and tool for grading or assessing the completeness of an organization in terms of being a functional AOA. The AOA Assessment Tool provides actionable insights for network owners, leaders, and administrators. The Assessment Tool may, for example, identify elements of AOA that are missing or need to be enhanced, diagnose why CLHSs (or other organizations) are not making expected progress, track the developmental progress of CLHSs, and develop evidence of the role of AOA in CLHS success.

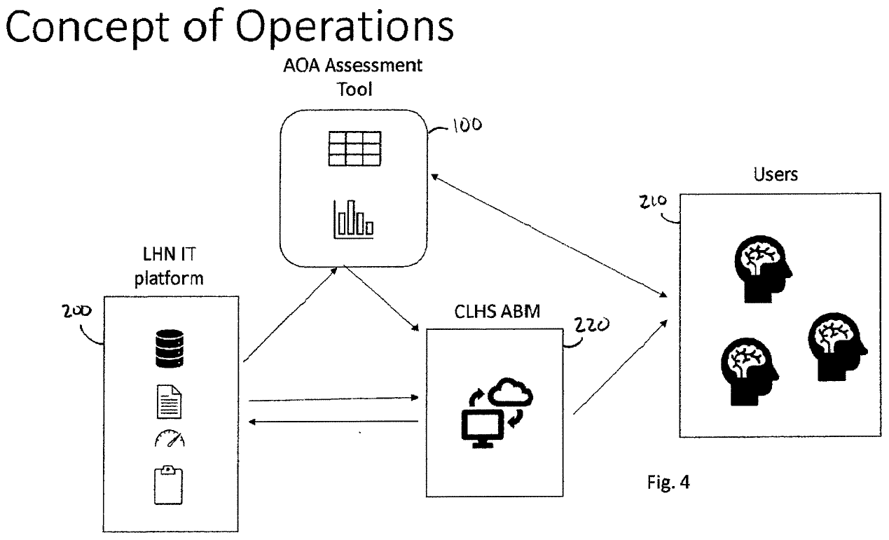

The Assessment Tool may be implemented, for example, in a suite of tools for improving CLHSs with the CLHS agent-based model (U.S. patent application Ser. No. 17/291,401, entitled “Computational Model of Learning Networks”, filed Nov. 5, 2019, and incorporated herein by reference) and Hive (CCHMC Tech ID 2018-0706). According to various aspects, data from one or more CLHS information platforms may be used for AOA Assessment, data from AOA Assessment and CLHS information platforms are input into a CLHS agent-based model (ABM), and ABM may provide bespoke guidance to CLHS leaders and platform builders for strategies for improving AOA. This is illustrated in FIG. 4 “Concept of Operations,” which is described in further detail below.

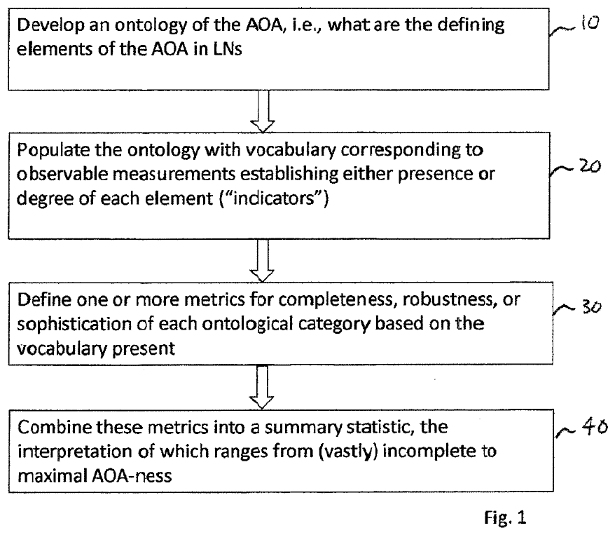

FIG. 1 illustrates an exemplary method including 4 high-level steps: (10) develop an ontology of the AOA, i.e., what are the defining elements of the AOA in LNs, (20) Populate the ontology with vocabulary corresponding to observable measurements establishing either presence or degree of each element (“indicators”), (30) define one or more metrics for completeness, robustness, or sophistication of each ontological category based on the vocabulary present, and (40) combine these metrics into a summary statistic, the interpretation of which ranges from (vastly) incomplete to maximal AOA-ness.

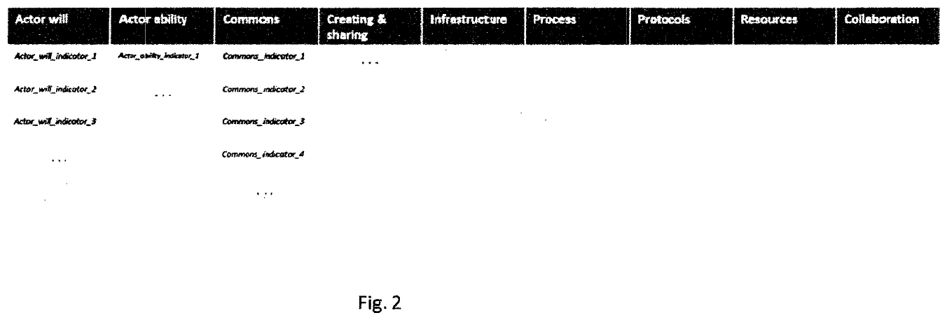

Step 1: Ontology. AOAs may utilize actors with the will and ability to self-organize; a commons where actors create and share resources; and infrastructure, processes, and protocols that facilitate multi-actor collaboration. This suggests a high-level AOA high-level ontology comprised of 9 categories described below. Accordingly, the ontology may be represented as a matrix with 9 columns corresponding to the categories of the ontology and rows populated with indicators of activities in each category, as depicted in FIG. 2.

Step 2: Indicators for the 9 categories of the ontology may include:

(1) Actors with the will to self-organize. The concept in this category is that key stakeholders are relentlessly focused on changing outcomes. Individuals and institutions are committed to the shared goal and have a sense of agency. Indicators of this concept may include information regarding an actor's will. A first actor will indicator (e.g., actor_will_indicator_1) can be based on the actors each sharing what the outcome is and the difference between the current outcome and the goal. A second actor will indicator (e.g., actor_will_indicator_2) can relate to individual-reported levels of commitment to achieving the goal. A third actor will indicator (e.g., actor_will_indicator_3) can be based on individual reporting on whether one can make a difference in reaching the goal. A fourth actor will indicator (e.g., actor_will_indicator_4) can be based on reported sense of accountability to the organization for achieving a goal.

Methods for finding such indicators may include surveys. Alternatively, an automated crawler could ingest a corpus of text or other data from the organization (e.g., commons materials, emails, messaging text, etc. housed by one or more IT platforms) and search for the indicators—for example, keyword searches for terms associated with indicators of each type. Other sophisticated natural language processing (NLP) approaches like Latent Dirichlet Allocation (LDA) topic modeling and ultimately machine learning may also be applicable to identify indicators. These and other related machine-based tools may be applied to all other indicators described below in the tool.

(2) Actors with the ability to self-organize. The concept in this category is that “Competent actors who have the knowledge, information, tools, and values needed to set goals, and assess the consequences of potential actions for the achievement of those goals, can self-organize” (Fjeldstad et al 2012). Actors have authority to decide where to focus at least some of their work and attention and ability to perform tasks beyond their stated job description in service of the shared goal. Managers and/or supervisors, for example, can encourage and reward this autonomy. Indicators of these concepts may include information regarding an actor's ability. A first actor ability indicator (e.g., actor_ability_indicator_1) can relate to one's availability of slack/flex time. A second actor ability indicator (e.g., actor_ability_indicator_2) can relate to individual reporting regarding people they collaborate with, and whether those individuals volunteer and follow through. A third actor ability indicator (e.g., actor_ability_indicator_3) can relate to a rubric for promotion, performance review, autonomy, self-organization, and the like. Methods for assessing these concepts may include document review, skills assessment (e.g., an ability to do quality improvement), and surveys.

(3) A commons. The concept in this category is of accessible shared space (in-person or virtual) where actors interact to create and share resources. Resources are findable. Resources may be pushed to actors based on anticipated need. Indicators of these concepts may include a first commons indicator (e.g., commons_indicator_1) relating to huddles, action-period calls, learning sessions, community conferences, all teach, all learn events, and similar interactive events. A second commons indicator (e.g., commons_indicator_2) may include virtual platform characteristics including search and retrieval function, organization, etc. A third commons indicator (e.g., commons_indicator_2) may relate to users finding resources in the commons. Methods may include review of artifacts, platform data such as count of logins and weekly logins, and search ‘audit’ for determining whether resources for particular uses can be found.

(4) Creating and sharing. The concept in this category is that a commons is not only a repository. It may also be a space where actors interact to create and share resources. Indicators of these concepts may include a first creating sharing indicator (e.g., creating_sharing_indicator_1) relating to interactions among actors, a second creating sharing indicator (e.g., creating_sharing_indicator_2) relating to posts, a third creating sharing indicator (e.g., creating_sharing_indicator_3) relating to downloads. Additional creating sharing indicators may be utilized as applicable to, based on characteristics of the commons. Methods may include review of in-person artifacts and recordings, and observation of behaviors from LHS IT platform.

(5) Infrastructures. The concept in this category is that “systems that connect actors allow actors to connect with one another as well as access the same information, knowledge, and other resources” (Fjeldstad et al., 2012). Indicators of these concepts include a first infrastructure indicator (e.g., infrastructure_indicator_1) relating to tools for convening, a second infrastructure indicator (e.g., infrastructure_indicator_2) relating to tools for connecting, a third infrastructure indicator (e.g., infrastructure_indicator_3) relating to shared situational awareness, and a fourth infrastructure indicator (e.g., infrastructure_indicator_4) relating to robust data architecture. Methods may include review of tools, dashboards, and data infrastructure artifacts.

(6) Processes. The concept in this category is that processes are the way work is done. These are known and used in ways that facilitate multi-actor collaboration. Indicators of these concepts may include a first process indicator (e.g., Process_indicator_1) relating to SOPs, a second process indicator (e.g., Process_indicator_2) relating to training, and a third process indicator (e.g., Process_indicator_3) relating to Competencies. Methods for determining one or more process indicators may include document review and observation.

(7) Protocols. The concept in this category is that “Protocols are codes of conduct used by organizational actors in their exchange and collaboration activities” (Fjeldstad et al., 2012). Indicators of these concepts may include a first protocol indicator (e.g., Protocol_indicator_1) relating to protocols by which actors advertise problems or opportunities as well as their own capabilities and availability, a second protocol indicator (e.g., Protocol_indicator_2) relating to protocols by which actors search for potential collaborators, and a third protocol indicator (e.g., Protocol_indicator_3) relating to other protocol categories deal with inter-actor coordination within the resulting network. Methods may include design elements, functionality of LHS IT platform (e.g., is it easy to know what needs to be done, find collaborators, start working together), document review (e.g., standard operating procedures (SOPs)), and stakeholder interviews.

(8) Resources. The concept in this category is information, knowledge, and knowhow for getting what is needed, when it's needed. Indicators of these concepts may include a first resource indicator (e.g., Resource_indicator_1) relating to a number of resources, a second resource indicator (e.g., Resource_indicator_2) relating to complexity of resources (e.g., simple or compound), a third resource indicator (e.g., Resource_indicator_3) relating to diversity of resource types, and a fourth resource indicator (e.g., Resource_indicator_4) relating to resources for different stakeholders. Methods for determining one or more resource indicators may include reviewing and mining of the commons.

(9) Self-organized multi-actor collaboration. The concept in this category is collaborative, lateral, reciprocal relationships among actors who work on common problems in dynamic, task-oriented groups. Indicators of these concepts may include a tool that analyzes organizational digital communication patterns. According to various examples, a first collaboration indicator (e.g., Collaboration_indicator_1) may relate to when people schedule communication, a second collaboration indicator (e.g., Collaboration_indicator_2) may relate to determining who people communicate with, a third collaboration indicator (e.g., Collaboration_indicator_3) may relate to how people communicate, and a fourth collaboration indicator (e.g., Collaboration_indicator_4) may relate to what people communicate. Methods to determine one or more collaboration indicators may include social network analysis.

Step 3-4: Metrics and Summary Statistics. After collecting indicators for the various ontology categories, the indicators may need to be weighted. In the simplest case, each indicator is weighted equally. However, non-equal weights may be needed to recognize that not all indicators are equally important or necessarily distinct. Specifically, more important indicators can be weighted more heavily than less important indicators. For example, in the case of a resource indicator relating to complexity of resources (e.g., Resource_indicator_2), a commons containing meeting minutes may qualify for 1 point whereas a commons containing one or more patient toolkits may qualify for 10 points.

After weighting the indicators, statistics may be computed. Two types of statistics may be provided: a category score and a system score.

(1) Category scores: For each category, a score may be computed. Different scores possible, a simplistic score could be defined as:

$$Category Score = \frac{Sum of Weights Assigned}{Sum of Possible Weights}$$

In an example, each such category ratio may range from 0 to 1.

(2) Systemic score: The category scores may be combined into a single overall system score. One example of a systemic score, based on the category metrics defined above, could be defined as:

$$Systemic Score = \frac{\begin{matrix}Sum of Category Score Numerators \\ ( i . e . , Sum of Weights Assigned )\end{matrix}}{\begin{matrix}Sum of Category Score Denominators \\ ( i . e . , Sum of Possible Weights )\end{matrix}}$$

In an example, the systemic score may range from 0 to 1.

To illustrate, an interpretation of such statistics could be that lower category scores (e.g., <0.5) denote categories needing further development whereas higher category scores denote less need of development. Lower system scores (e.g., <0.5) suggest that the organization has additional work to do to become a stronger AOA whereas higher system scores suggest overall strength but with room for improvement.

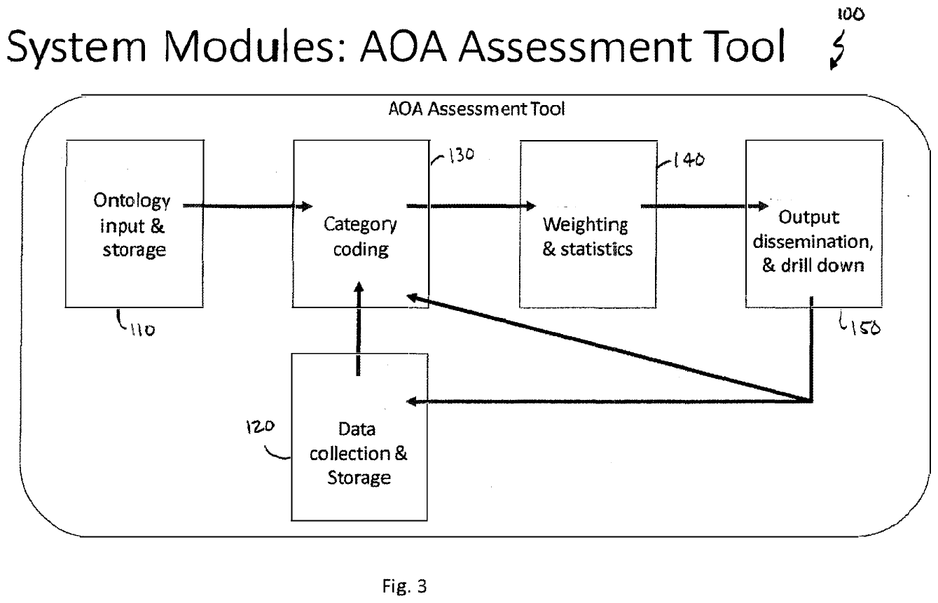

Referring to FIG. 3, according to various aspects, the AOA Assessment Tool 100 may provide users with different outputs (e.g., via The Output, Determination and Drill Down Module 150).

An indicator matrix and dashboard may depict individual scores and weights within each category, including but not limited to category statistics and system statistics. The AOA Assessment Tool 100 may also include drill-down access to discover what is responsible for specific scores. This will allow, for example, users to ask questions such as “Our organization scored highly in Category X and specifically indicators A and B, but why is that?”

FIG. 3 illustrates an example AOA Assessment Tool 100 system. The AOA assessment tool 100 may include five modules. The Ontology Input and Storage Module 110 receives and stores the specification of an organizational ontology (in an example case, this could be an ontology of an AOA). The specification could be provided in a knowledge model language such as Web Ontology Language (OWL) or in a flat text file with ontology structure, vocabulary (as referred to herein, “vocabulary” may be a synonym for “indicators” for the purposes of this disclosure), and relations between ontological elements specified in standard ontology structure (e.g., Basic Formal Ontology) or non-standard ontology structure.

The Data Collection and Storage Module 120 may collect and store files (e.g., documents) related to the organization to be assessed (e.g., a LHN), possibly but not necessarily provided by the organization itself, in such a way that it can be searched in the Category Coding Module 130. In different embodiments, collection of such files/documents may utilize machine methods (e.g., an automated crawler could ingest documents in various formats from the organization residing in one or more information commons, email, messaging text, etc. housed on one or more IT platforms) solely, manual methods (e.g., manual copying of files from one or more locations to a central repository) solely, or a combination of machine and manual methods. In another embodiment, document locations are merely recorded and accessed in the Category Coding Module 130 at the identified electronic addresses. Some embodiments include converting files to a common format (e.g., text files) to support the Category Coding Module 130 and the Output Dissemination and Drill Down Module 150. Other embodiments do not require converting files to a common, specific format.

The Category Coding Module 130 searches and analyzes information contained in files from the Data Collection and Storage Module 120 and associates those files with elements and vocabulary of the ontology stored in the Ontology Input and Storage Module 110. In one embodiment, the Category Coding Module 130 searches files from the Data Collection and Storage Module 120 for specific ontology vocabulary. In another embodiment, the Category Coding Module 130 employs supervised or unsupervised machine learning (ML) models to identify material in files corresponding to ontology vocabulary. In yet another embodiment, the Category Coding Module 130 utilizes NLP techniques such as topic modeling to identify material in files corresponding to ontology vocabulary. Other embodiments may utilize two or more such methods to identify material in files corresponding to ontology vocabulary. Some embodiments may include search, ML, and NLP tools requiring a common file format (e.g., text or comma separated value) whereas other embodiment may utilize tools that do not require common or specific formats. The results of the processes executed in the Category Coding Module 130 are stored on one or more servers (which may be cloud-based in an embodiment) accessible to the Weighting and Statistics Module 140 and the Output, Determination and Drill Down Module 150 for additional processing.

The Statistics and Scoring Module 140 receives the ontology vocabulary produced by the Category Coding Module 130 and assigns weights to each according to the importance of some indicators relative to others. Weights account for the possibility that not all indicators are equally important or necessarily distinct. In one embodiment, each vocabulary term is weighted equally. In other embodiments, vocabulary known or suspected to be more important are weighted more heavily than those known or suspected to be less important. The weights versus indicators/vocabulary-terms table/relationship may be pre-loaded (predetermined) into the Weighting and Statistics Module 140.

After weighting, the Weighting and Statistics Module 140 computes statistics based on the weights. Two categories of statistics are computed: (a) category statistics, which for each category of ontological indicators are calculated from the weights; and (b) systemic statistic, which combine category statistics into a single overall system statistic. In one embodiment, both types of statistic are computed as the ratio of a numerator to denominator where numerators are sums of weights produced by the Category Coding Module 130 and denominators are sums of all possible weights. In another embodiment, alternate statistics are computed based on other linear or nonlinear functions of weights.

The Output Dissemination and Drill Down Module 150 receives statistics computed by the Weighting and Statistics Module 140 and displays the statistics and how they were derived in terms of the ontology indicators and weights. The Output, Determination and Drill Down Module 150 provides a drill-down capability whereby users may investigate the reasons for the scores along the continuum of low to high category statistics. This is achieved by the Category Coding Module 130 and the Weighting and Statistics Module 140 passing metadata that records which files are associated with different ontology vocabulary and how those vocabulary are weighted. The Output, Determination and Drill Down Module 150 uses these records to allow users to access documents corresponding to different ontology categories in order to understand category scores and thus better understand low versus high scores for different categories.

As referenced above, the modules can have several embodiments. At the more basic level, the modules may provide a minimal tool functionality. For example, the Data Collection and Storage Module 120 employs manual file collection methods (e.g., manual copying of files from one or more locations to a central repository) solely, stores all files in a single storage location on a server or platform, and converts all textual files into a common format for processing—the consequence of these choices includes limitations on number, frequency, and type of documents collected, and corresponding limitations on the representativeness of the statistics computed in the Weighting and Statistics Module 140; the Category Coding Module 130 employs commonly available search tools to search files from the Data Collection and Storage Module 120 for ontology vocabulary or synonyms of that vocabulary; the Weighting and Statistics Module 140 employs equal weights (trivially, a weight of 1) to all ontology vocabulary produced in the Category Coding Module 130, and also employs statistics calculated as simple ratios; and the Output, Determination and Drill Down Module 150 reports only the summary statistics (and not how the statistics were computed and does not provide any drill down functionality).

At a more complex level, to produce a more robust and capable set of functionality: the Data Collection and Storage Module 120 employs both manual and machine-based file collection methods (e.g., manual copying of files from one or more locations to a central repository combined with crawling technologies accessing a plurality of data sources) and identifies the address locations of relevant files regardless of file formats—the consequence of these choices is the removal of the limitations cited in the corresponding minimal case—specifically, these embodiments will maximize the representativeness of the statistics computed in the Weighting and Statistics Module 140; the Category Coding Module 130 employs commonly available search tools to search files from the Data Collection and Storage Module 120 for ontology vocabulary or synonyms of that vocabulary as well as applies machine learning, natural language processing techniques to accomplish the same—the tools will be capable of ingesting files of different formats located in different locations, as opposed to ingesting in a single file format and from a single file area—these choices will maximize the likelihood of finding relevant ontological elements and vocabulary in the files of the Data Collection and Storage Module 120; the Weighting and Statistics Module 140 employs differential weights to ontology vocabulary produced in the Category Coding Module 130 according to different levels of importance, and also employs choices of statistics, including both simple ratios and other (potentially user-defined) statistics and metrics; and the Output, Determination and Drill Down Module 150 reports the summary statistics, how the statistics were computed, and also provides drill down functionality.

An exemplary Concept of Operations is depicted in FIG. 4. Existing LHNs utilize one or more IT platforms (e.g., Hive Networks' suite of tools) 200 where data corresponding to The Data Collection and Storage Module 120 typically reside or could be made to reside (i.e., surveys could be administered from such a platform and/or the results of such surveys could be housed on the platform). One or more LHN IT platforms 200 provide data to the AOA Assessment Tool 100 (The Data Collection and Storage Module 120) and the Tool 100 then executes Steps 1-5 utilizing the plurality of Modules. The Output, Determination and Drill Down Module 150 provides information and functionality to users 210 to interpret and understand the Tool output. Analytic tools 220 such as but not limited to simulation models (e.g., U.S. patent application Ser. No. 17/291,401, entitled “Computational Model of Learning Networks”, filed Nov. 5, 2019) may enable forming LHNs or mature LHNs optimize. The AOA Assessment Tool 100 may assist with informing such analytic tools 220 by measuring the relative strength of different parts of specific LHNs, thereby allowing tools to be better tailored to networks.

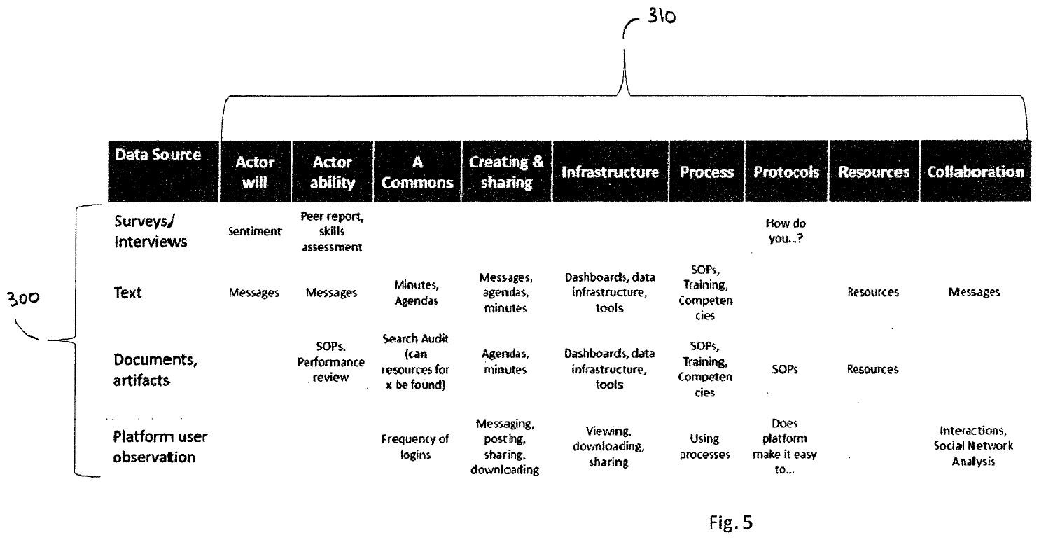

FIG. 5 illustrates how the AOA assessment tool 100 may interact with different data sources 300 to produce matrix elements 310.

### Exemplar Applications and Use Cases.

In an example, more than one LN leader describes care centers that don't participate or are unsure they will be able to continue in the LN (the cause is attributed to overwork or lack of institutional funds). The AOA assessment tool 100 according to the current disclosure shows variability in actor-orientation and behavior across care centers and specific ways in which this manifests (e.g., no ability for care center staff to flex their time, few downloads, sporadic messaging). The AOA assessment tool 100 text mining shows common work/interests could connect these care centers to well performing ones. CLHS ABM 220 may simulate (a) amount of change across AOA categories required (e.g., increase messaging by 10%, free up three hours/week flex time); and/or (b) increase in network outcomes if these care centers were at median (incentivizes well-performing care center personnel to reach out to peers at other care centers). Specific, actionable interventions can be tested. For example, staff with similar work at high-performing sites are prompted to reach out to colleagues at at-risk care centers while the tool 100 monitors for increases in messaging and/or downloads. As another example, care center leads who have negotiated with their institutions for flex time for staff are prompted to coach their colleagues at at-risk care centers while the tool 100 monitors messaging, increases in flex time.

### Commercial/Collaborative Interests

Aspects discussed herein may be relevant in several scenarios, including but not limited to leaders of a mature LN (e.g., to determine opportunities to improve the organization), founders of a new LN (e.g., to determine tasks and needs in the early days of a network), IT platform owners (e.g., to determine how to best position technology to optimally support different networks), thought leaders (e.g., to determine how LNs might be best suited to respond to public health or other national emergencies), and researchers (e.g., to compare different networks in terms of structure, AOA functionality, etc.).

It should be understood that the disclosed approach to measure degree of AOA-ness for learning health networks and is applicable to other, non-health related collaborative movements and organizations (open-source software, industry interest groups, purpose-based “crash efforts”, et al). The approach can incorporate any ontology—it is not limited to the ontology illustrated above—and can apply to any organizational schema. It is agnostic to organization type, provided an ontology can be built to describe the organization type.

### Potential Clinical Impact

By assessing the state of LNs and identifying science-based areas for improvement as well as areas not needing additional investment, this tool can help to more rapidly optimize LNs and thus improve outcomes in existing and new LNs. This will directly impact patient care and outcomes, as shown historically in LNs associated with applicant.

### Disease Prevalence/Market Size

The AOA Assessment Tool is conceived to aid in the scaling and optimization of CLHSs. This requires a market that understands and values LNs. The current market for LN optimization tools is nascent and small but growing and with the potential for large growth in the near-term. Moreover, an AOA Assessment Tool could spur the growth and ultimate size of the market.

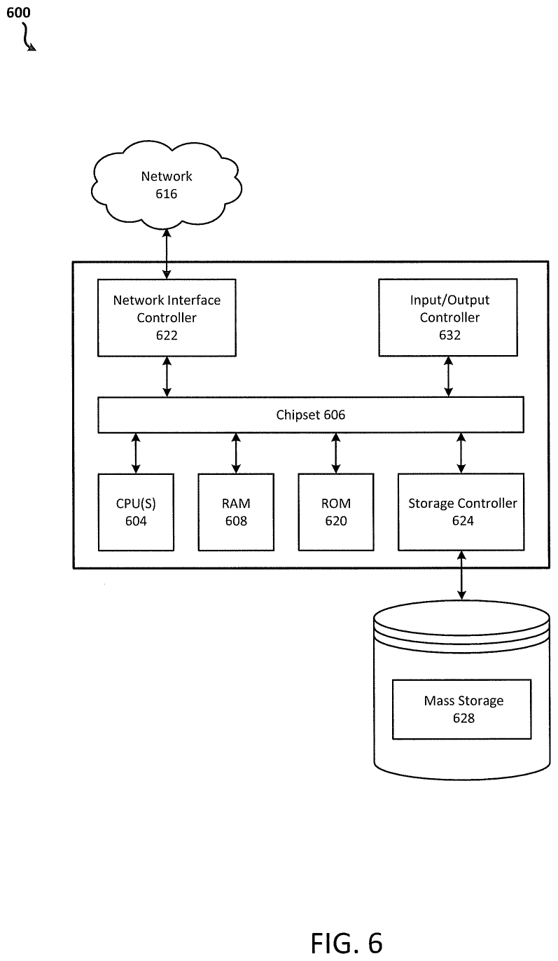

FIG. 6 depicts a computing device that may be used in various aspects, such as implementing any of the methods and modules discussed in FIGS. 1-5. For example, the system Modules 110, 120, 130, 140, 150, the AOA Assessment Tool 100, and various aspects can be implemented in one or more instances of a computing device 600 of FIG. 6.

The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 1-5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like. The CPU(s) 604 may be augmented with or replaced by other processing units, such as GPU(s). The GPU(s) may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIGS. 1-5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems disclosed herein are not limited to specific methods, specific components, specific elements, or to particular implementations. It is also to be understood that the terminology used herein is for the purpose of describing particular embodiments only and is not intended to be limiting. “Optional” or “optionally” (or similar statements reflecting options such as “may include” or “can provide”) means that the subsequently described element, component, event or circumstance may or may not be present or may or may not occur, and that the description includes instances where the element/component is present and circumstances where it is not. Likewise, the description includes instances where the event or circumstance occurs and instances where it does not. Throughout the description and claims of this specification, the word “comprise” and variations of the word, such as “comprising,” “comprises,” “includes,” and “including” means “including but not limited to,” and is not intended to exclude, for example, other components, elements, integers or steps. Indeed, unless the specification or claims expressly state that components, elements, integers or steps are excluded, then it is intended that such components, elements, integers or steps may or may not be excluded. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems (and disclosed Modules 110, 120, 130, 140 and 150) may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium (which may be a non-transitory storage medium). More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to written discussions, listed steps or sequences, example user interface sequences, block diagrams and/or flowchart illustrations of methods, systems, apparatuses and computer program products. It will be understood that each may be implemented by computer program instructions. For example, Modules 110, 120, 130, 140 and 150 may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the written discussions, user interface sequences, block diagrams and/or flowcharts.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the written discussions, user interface sequences, block diagrams and/or flowcharts. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the written discussions, user interface sequences, block diagrams and/or flowcharts.

The various features and processes described above may be used independently of one another, or may be combined in various ways. For example, it is possible that any of Modules 110, 120, 130, 140 and 150 may be combined with each other (i.e., describing and claiming the Modules 110, 120, 130, 140 and 150 separately does not necessarily require that the Modules must be distinct/separable from each other). All possible combinations and sub-combinations are intended to fall within the scope of this disclosure. In addition, certain methods or process blocks may be omitted in some implementations. The methods and processes described herein are also not limited to any particular sequence, and the blocks, steps or states relating thereto may be performed in other sequences that are appropriate. For example, described blocks, steps or states may be performed in an order other than that specifically described, or multiple blocks, steps or states may be combined in a single block, step or state. The example blocks, steps or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, a server, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present disclosure may be practiced with other computer system configurations.

Having disclosed the inventions claimed herein in reference to a number of potential embodiments and examples, it will be understood that it is not intended that any details from such embodiments be incorporated into the plain and ordinary meaning of any of the following claim terms.

What is claimed is:

1. A computer-implemented method for assessing a learning network (LN), comprising:
collecting data related to an organization to be assessed, wherein the data comprises LN capabilities data indidcative of at least one of: LN structure, information use, and function;
analyzing the data with respect to a set of indicators associated with an organizational ontology of an actor-oriented architecture (AOA), the AOA including (a) presence of sufficient actors with the will and capacity to self organize, (b) a commons where the actors create and share resources, and (c) mechanisms to facilitate multi-actor collaboration;
determining a strength of LN capabilities for each indicator in the set of indicators; and
generating a dashboard, on a graphical user interface, graphically communicating at least one summary-statistic indicative of the strength of LN capabilities.

2. The computer-implemented method of claim 1, further comprising providing the capability to understand the scores within a context of network data.

3. The computer-implemented method of claim 1, further comprising:
generating the organizational ontology of the AOA, wherein the organizational ontology comprises a set of LN capabilities and a relation to the set of indicators; and
populating the organizational ontology with vocabulary corresponding to observable measurements establishing either presence or degree of each of the set of indicators.

4. The computerized-implemented method of claim 3, further comprising:
generating one or more metrics indicative of at least one of: completeness, robustness, and sophistication for an ontological category, wherein the ontological category is based on the vocabulary;
combining the one or more metrics into a second summary-statistic; and
providing the second summary-statistic on the dashboard.

5. The computer-implemented method of claim 1, wherein the set of indicators include at least one of:
(1) actor ability to self-organize;
(2) commons where actors accumulate and share resources; and
(3) enablement of multi-actor collaboration.

6. The computer-implemented method of claim 1, further comprising the step of weighting the set of indicators such that more important indicators are weighted more heavily than less important indicators.

7. The computer-implemented method of claim 1, wherein the at least one summary-statistic includes a score for each indicator in the set of indicators.

8. The computer-implemented method of claim 1, wherein the at least one summary-statistic includes an overall system score, which is a combination of score for elements/categories/indicators.

9. The computer-implemented method of claim 1, wherein the dashboard provides drill-down access to discover more details about specific scores or statistics.

10. The computer-implemented method of claim 1, wherein the LN includes a plurality of patient actors and a plurality of clinician actors sharing information about treatments and outcomes.

11. A computerized system, comprising:
an ontology input module configured provide a specification of an organizational ontology, the ontology including a set of indicators associated with an organization;
a data collection module comprising data related to an organization to be assessed;
a category coding module configured to analyze data from the data collection module with respect to the set of indicators;
a scoring module configured to perform at least one of: scoring the analysis and generating statistics from the analysis conducted by the category coding module; and
an output dissemination module configured to output a least one of: a score and a statistic to a user.

12. The computerized system of claim 11, wherein the organization is associated with a collaborative learning health system (CLHS) or other types of collaborative organizations.

13. The computerized system of claim 11, wherein the set of indicators are associated with an actor-oriented architecture (AOA) for effective collaborative environments.

14. The computerized system of claim 11, wherein the set of indicators include at least one of:
(1) actor ability to self-organize;
(2) commons where actors accumulate and share resources; and
(3) enablement of multi-actor collaboration.

15. The computerized system of claim 11, wherein at least one of the category coding module and the scoring module assigns weights to each indicator in the set of indicators, and wherein more important indicators are weighted more heavily than less important indicators.

16. The computerized system of claim 11, wherein the scoring module generates at least one of:
a score for each indicator in the set of indicators; and
an overall system score comprising a combination of scores for the set of indicators.

17. The computerized system of claim 11, wherein the output dissemination module provides at least one of: a score and a statistic to a user via a graphical dashboard, and wherein the dashboard provides at least one selection to provide more details about at least one of the score and the statistic.

18. One or more non-transitory memory devices including computer instructions configured to direct one or more computer processors to perform the computer-implemented method of:
collecting data related to an organization to be assessed, wherein the data comprises learning network (LN) capabilities data indidcative of at least one of: LN structure, information use, and function;
analyzing the data with respect to a set of indicators associated with an organizational ontology of an actor-oriented architecture (AOA), the AOA including (a) presence of sufficient actors with the will and capacity to self organize, (b) a commons where the actors create and share resources, and (c) mechanisms to facilitate multi-actor collaboration;
determining a strength of LN capabilities for each indicator in the set of indicators; and
generating a dashboard, on a graphical user interface, graphically communicating at least one summary-statistic indicative of the strength of LN capabilities.
